(19) United States
(12) Patent Application Publication
(10) Pub. No.: US 2012/0022767 A1
(43) Pub. Date: Jan. 26, 2012

(54) ERROR DETECTOR FOR INJECTION CHARACTERISTIC DATA

(75) Inventor: Masakazu SAKATA, Obu-city (JP)

(73) Assignee: DENSO CORPORATION, Kariya-city (JP)

(21) Appl. No.: 13/189,820

(22) Filed: Jul. 25, 2011

(30) Foreign Application Priority Data
Jul. 26, 2010 (JP) 2010-166681

(51) Int. Cl. F02D 41/30

(52) U.S. Cl. 701/103

(57) ABSTRACT

An error detector includes an injector-memory provided to a fuel injector injecting a fuel into an internal combustion engine, and an ECU-memory provided to an ECU. The injector-memory stores a characteristic data indicative of injection characteristics of the fuel injector. The ECU-memory stores a characteristic data which is identical to the data stored in the injector-memory. The injector-memory further stores another characteristic data which is identical to the characteristic data stored in the injector-memory. The ECU compares three characteristic data stored in the injector-memory and the ECU-memory to determine whether three characteristic data are identical to each other, whereby an error is detected.

### CROSS-REFERENCE TO RELATED APPLICATION

This application is based on Japanese Patent Application No. 2010-166681 filed on Jul. 26, 2010, the disclosure of which is incorporated herein by reference.

### FIELD OF THE INVENTION

The present invention relates to an error detector which detects an error in fuel injection characteristic data of a fuel injector.

### BACKGROUND OF THE INVENTION

An injection characteristic of a fuel injector includes delay in response between an injection-command signal and an actual fuel injection, a maximum fuel injection rate and the like. JP-2009-57926A (US-2009/0056676A1) shows that various injection characteristics of an injector are obtained by experiments before the injector is shipped and the characteristic data are stored in a memory provided to the injector. This memory is referred to as an INJ-memory, hereinafter. According to this, even after the injector mounted on an internal combustion engine is shipped, an electronic control unit (ECU) can control an operation of the injector based on the characteristic data stored in the INJ-memory, whereby the injection condition can be accurately controlled.

If the ECU receives the characteristic data from the INJ-memory every when the injection-command signal is computed, the processing load between the ECU and the INJ-memory becomes huge and a high communication speed is required.

In the invention shown in JP-2009-57926A, the characteristic data stored in the INJ-memory are copied to a memory provided to the ECU. This memory provided to the ECU is referred to as an ECU-memory, hereinafter. A microcomputer of the ECU obtains the characteristic data from the ECU-memory to control an operation of the injector.

However, with respect to both of the INJ-memory and the ECU-memory, a failure of copying data and/or noises generates an error in the characteristic data. Thus, it is necessary to detect such an error and to obtain correct characteristic data.

### SUMMARY OF THE INVENTION

The present invention is made in view of the above matters, and it is an object of the present invention to provide an error detector which can detect an error in fuel injection characteristic data of a fuel injector and obtain correct characteristic data.

According to the present invention, an error detector includes an injector-memory provided to a fuel injector injecting a fuel into an internal combustion engine and a controller-memory means provided to a controller controlling the fuel injector. The injector-memory stores a first characteristic data indicative of injection characteristics of the fuel injector, and the controller-memory means stores a second characteristic data which is identical to the first characteristic data. At least one of the injector-memory means and the controller-memory means further stores a third characteristic data which is identical to the first and the second characteristic data. At least the first to the third characteristic data is compared with each other in order to detect an error in one of the characteristic data.

### BRIEF DESCRIPTION OF THE DRAWINGS

Other objects, features and advantages of the present invention will become more apparent from the following description made with reference to the accompanying drawings, in which like parts are designated by like reference numbers and in which:

FIG. 1 is a schematic view showing a fuel injection system including an error detector and a fuel-injector according to an embodiment of the present invention;

FIG. 2A is a time chart showing a fuel-injection-command signal;

FIG. 2B is a time chart showing a variation in fuel-injection rate;

FIG. 2C is a time chart showing a detection pressure detected by a fuel pressure sensor;

FIG. 3 is a block diagram showing the fuel injection controller;

FIG. 4 is a flow chart showing a learning processing of characteristic data;

FIG. 5 is a flow chart showing an updating processing of characteristic data; and

FIG. 6 is a flow chart showing a determination processing of characteristic data.

### DETAILED DESCRIPTION OF EMBODIMENTS

Hereafter, an embodiment of an error detector for injection characteristic data according to the present invention will be described, hereinafter. An error detector is applied to an internal combustion engine (diesel engine) 100 having four cylinders #1-#4.

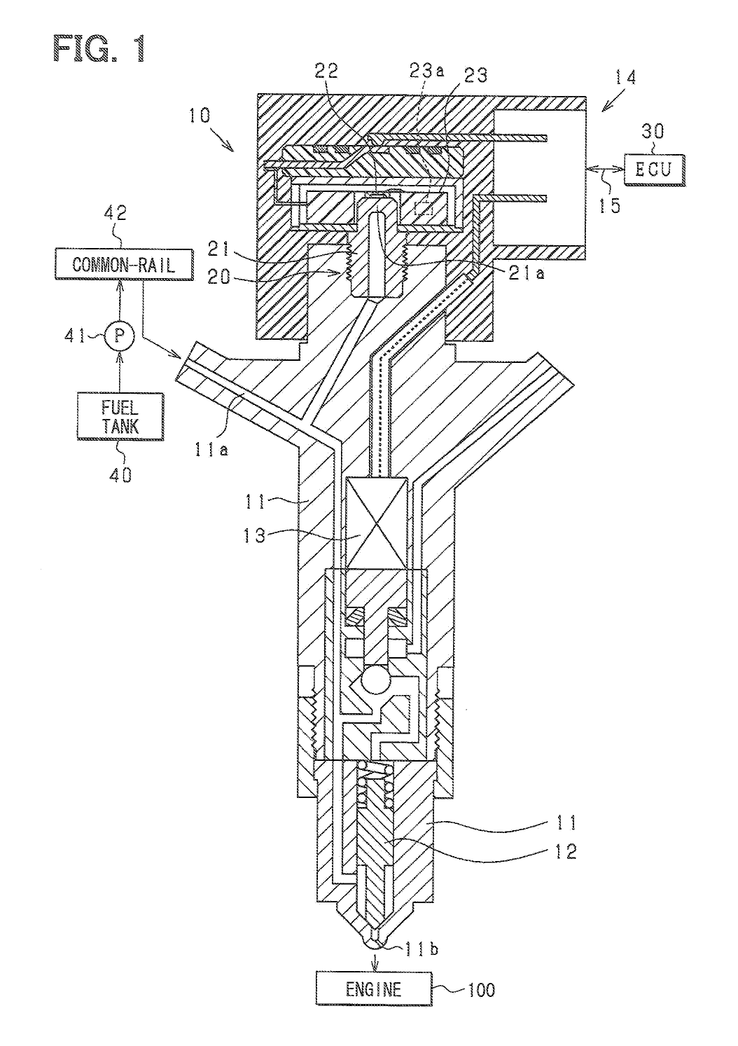

FIG. 1 is a schematic view showing a fuel injector 10 provided to each cylinder, a fuel pressure sensor 20 provided to the fuel injector 10, and an electronic control unit (ECU)

First, a fuel injection system of the engine 100 including the fuel injector 10 will be explained. A fuel in a fuel tank 40 is pumped up by a high-pressure pump 41 and is accumulated in a common-rail 42 to be supplied to each injector 10.

The fuel injector 10 is comprised of a body 11, a needle (valve body) 12, an actuator 13 and the like. The body 11 defines a high-pressure passage 11a and an injection port 11b. The needle 12 is accommodated in the body 11 to open/close the injection port 11b. The actuator 13 drives the needle 12.

The ECU 30 controls the actuator 13 to drive the needle 12. When the needle 12 opens the injection port 11b, high-pressure fuel in the high pressure passage 11a is injected to a combustion chamber (not shown) of the engine 100. The ECU 30 computes a target fuel-injection condition, such as a fuel injection start timing, a fuel injection end timing, a fuel injection quantity and the like based on an engine speed, an engine load and the like. The ECU 30 transmits a fuel-injection-command signal to the actuator 13 in order to drive the needle 12 in such a manner as to obtain the above target fuel-injection condition.

A structure of the fuel pressure sensor 20 will be described hereinafter.

The fuel pressure sensor 20 includes a stem (load cell), a pressure sensor element 22 and a molded IC 23. The stem 21 is provided to the body 11. The stem 21 has a diaphragm 21a which elastically deforms in response to high fuel pressure in the high pressure passage 11a. The pressure sensor element 22 is disposed on the diaphragm 21a to output a pressure detection signal depending on an elastic deformation of the diaphragm 21a.

The molded IC 23 includes an amplifying circuit which amplifies the pressure detection signal outputted from the pressure sensor element 22. Further, the molded IC 23 includes an EEPROM 23a which is a rewritable nonvolatile memory. This EEPROM 23a corresponds to an INJ-memory. A connector 14 is provided on the body 11. The molded IC 23, the actuator 13 and the ECU 30 are electrically connected to each other through a harness 15 connected to the connector 14.

When the fuel injection is started, the fuel pressure in the high pressure passage 11a starts to decrease. When the fuel injection is terminated, the fuel pressure in the high pressure passage 11a starts to increase. That is, a variation in the fuel pressure and a variation in the injection rate have a correlation, so that the variation in the injection rate (actual fuel-injection condition) can be detected from the variation in the fuel pressure. The fuel-injection-command signal is corrected so that the detected actual fuel-injection condition agrees with the target fuel-injection condition. Thereby, the fuel-injection condition can be controlled with high accuracy.

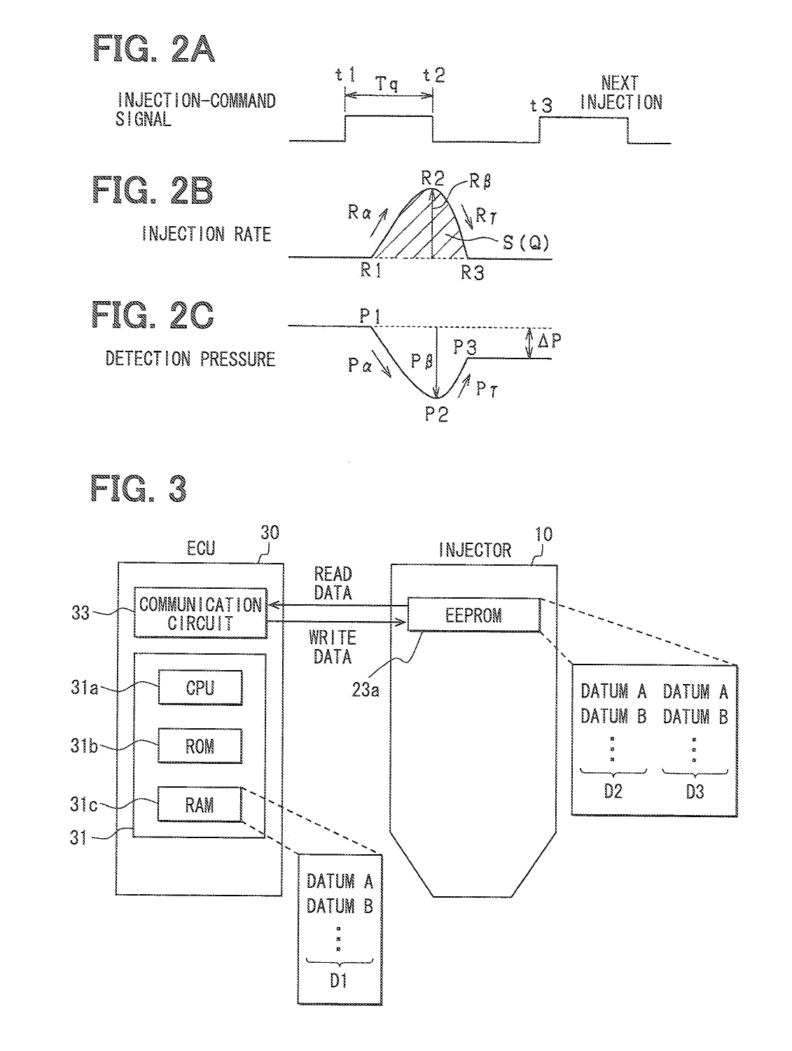

Referring to FIGS. 2A to 2C, a correlation between the variation in fuel pressure detected by the fuel sensor 20 and the variation in fuel injection rate will be described.

FIG. 2A shows fuel-injection-command signals which the ECU 30 outputs to the actuator 13. Based on this injection-command signal, the actuator 13 operates to open the injection port 11b. That is, a fuel injection is started at a pulse-on timing “t1” of the injection-command signal, and the fuel injection is terminated at a pulse-off timing “t2” of the injection-command signal. During a time period “Tq” from the timing “Is” to the timing “Ie”, the injection port 11b is opened. By controlling the time period “Tq”, the fuel injection quantity “Q” is controlled.

FIG. 2B shows a waveform of variation in fuel-injection rate, and FIG. 2C shows a waveform of variation in detection pressure. Since the variation in the detection pressure and the variation in the injection rate have a relationship described below, a waveform of the injection rate can be estimated (detected) based on a waveform of the detection pressure.

That is, as shown in FIG. 2A, after the injection command signal rises at the timing “t1”, the fuel injection is started and the injection rate starts to increase at a timing “R1”. When the injection rate starts to increase at the timing “R1”, the detection pressure starts to decrease at a point “P1”. Then, when the injection rate reaches the maximum injection rate at a timing “R2”, the detection pressure drop is stopped at a point “P2”. When the injection rate starts to decrease at a timing “R2”, the detection pressure starts to increase at the point “P2”. Then, when the injection rate becomes zero and the actual fuel injection is terminated at a timing “R3”, the increase in the detection pressure is stopped at a point “P3”.

As described above, by detecting the points “P1” and “P3”, the actual fuel-injection-start timing “R1” and the actual fuel-injection-end timing “R3” can be computed. Based on a relationship between the variation in the detection pressure and the variation in the fuel injection rate, which will be described below, the variation in the fuel injection rate can be estimated from the variation in the detection pressure.

That is, a decreasing rate “Pα” of the detection pressure from the point “P1” to the point “P2” has a correlation with an increasing rate “Rα” of the injection rate from the timing “R1” to the timing “R2”. An increasing rate “Pγ” of the detection pressure from the point “P2” to the point “P3” has a correlation with a decreasing rate “Rγ” of the injection rate from the timing “R2” to the timing “R3”. A maximum fuel-pressure-drop amount “Pβ” of the detected pressure has a correlation with a maximum injection rate “Rβ”. Therefore, the increasing rate “Rα” of the injection rate, the decreasing rate “Rγ” of the injection rate and the maximum injection rate “Rβ” can be computed by detecting the decreasing rate “Pα” of the detection pressure, the increasing rate “Pγ” of the detection pressure and the maximum fuel-pressure-drop amount “Pβ” of the detection pressure. The variation in the injection rate (variation waveform) shown in FIG. 2B can be estimated by computing the timings “R1”, “R3”, the rates “Rα”, “Rγ” and the maximum injection rate “Rβ”.

Furthermore, an integral value “S” of the injection rate from the timing R1 to the timing R3 (shaded area in FIG. 2B) is equivalent to the injection quantity “Q”. An integral value of the detection pressure from the timing P1 to the timing P3 has a correlation with the integral value “S” of the injection rate. Thus, the integral value “S” of the injection rate, which corresponds to the injection quantity “Q”, can be computed by computing the integral value of detection pressure.

The ECU 30 has a microcomputer 31 which computes a target fuel-injection condition based on engine load and engine speed, which are derived from an accelerator position. For example, the microcomputer stores an optimum fuel-injection condition (number of stages of fuel injection, fuel-injection-start timing, fuel-injection-end timing, fuel injection quantity and the like) with respect to the engine load and the engine speed as a fuel-injection condition map. Then, based on the current engine load and engine speed, the target fuel-injection condition is computed in view of the fuel-injection condition map. Then, based on the computed target fuel-injection condition, the fuel-injection-command signal represented by “t1”, “t2”, “Tq” is established. For example, the fuel-injection-command signal corresponding to the target fuel-injection condition is stored in a command map. Based on the computed target fuel-injection condition, the fuel-injection-command signal is established in view of the command map. As above, according to the engine load and the engine speed, the fuel-injection-command signal is established to be output to the injector 10.

It should be noted that the actual fuel-injection condition varies relative to the fuel-injection-command signal due to aging deterioration of the fuel injector 10, such as abrasion of the injection port 11b. In the present embodiment, a relationship between the fuel-injection-command signal (“t1”, “t2”, “tq”) and the fuel-injection condition (“R1”, “R3”, “Rα”, “Rβ”, “Rγ”, “Q”) is learned and stored as the specific characteristic data of the fuel injector 10. Then, based on the learned characteristic data, the fuel-injection-command signal stored in the command map is corrected. Thus, the fuel-injection condition can be accurately controlled so that the actual fuel-injection condition agrees with the target fuel-injection condition.

The actual fuel-injection-start timing “R1” can be learned as the response delay between the pulse-on timing “t1” and the actual fuel-injection-start timing “R1”. Also, the timings “R1” and “R3” can be learned as the fuel injection period. The fuel-pressure-drop ΔP from “P1” to “P3” can be learned as the control parameter.

As shown in FIG. 3, the ECU 30 includes a microcomputer 31 and a communication circuit 33 which functions as a communication interface. The microcomputer 31 includes a CPU 31a, a non-writable nonvolatile memory (ROM) 31b, and a writable volatile memory (RAM) 31c. This RAM 31c is referred to as an ECU-memory 31c, hereinafter. Even if an ignition switch is turned off, the electric power is supplied to the ECU-memory 31c from a backup power source (not shown), whereby the data stored in the ECU-memory 31c is not erased. However, if the backup power source (battery) is removed from the vehicle, the data stored in the ECU-memory 31c are erased.

The communication circuit 33 is electrically connected to an EEPROM 23a provided to the injector 10. This EEPROM 23a is referred to as an INJ-memory 23a, hereinafter. The microcomputer 31 can read the characteristic data stored in the INJ-memory 23a and can rewrite the characteristic data stored in the INJ-memory 23a into the characteristic data stored in the ECU-memory 31c which are updated. It should be noted that the ECU-memory 31c corresponds to a controller-memory means and the INJ-memory 23a corresponds to an injector-memory means.

The initial values of the characteristic data are previously obtained by experiments and are stored in the INJ-memory 23a before the injector 10 is shipped.

After the injector 10 is mounted in the engine, the ECU 30 obtains the initial characteristic data (base data) stored in the INJ-memory 23a. The obtained base data are stored in the ECU-memory 31c. After the engine is shipped, the characteristic data are learned and updated while the engine is running. The data stored in the ECU-memory 31c are successively updated.

The base data and the updated data are stored in the ECU-memory 31c and the INJ-memory 23a. The microcomputer 31 computes the fuel-injection-command signal based on the updated data in the learned region. Meanwhile, the microcomputer 31 computes the signal based on the base data in the unlearned region.

The updated data stored in the INJ-memory 23a are transmitted to the ECU-memory 31c when the engine is turned off. The data stored in the ECU-memory 32c are rewritten into the updated data stored in the INJ-memory 23a. Thus, during a period from the time when the engine is tuned off until the time when the engine is restarted, the characteristic data “D1” in the ECU-memory 31c is identical to the characteristic data “D2” in the INJ-memory 23a.

Further, as shown in FIG. 3, the INJ-memory 23a stores characteristic data “D3” which is identical to the characteristic data “D2”. The characteristic data “D3” includes the base data and the updated data. The base data in the characteristic data “D3” is stored in the INJ-memory 23a along with the characteristic data “D2” before shipping. The updated date in the characteristic data “D3” is transmitted from the ECU-memory 31c along with the characteristic data “D2” when the engine is turned off. In FIG. 3, each datum “A”, “B” respectively corresponds to the response delay time and the maximum injection-rate “Rβ”.

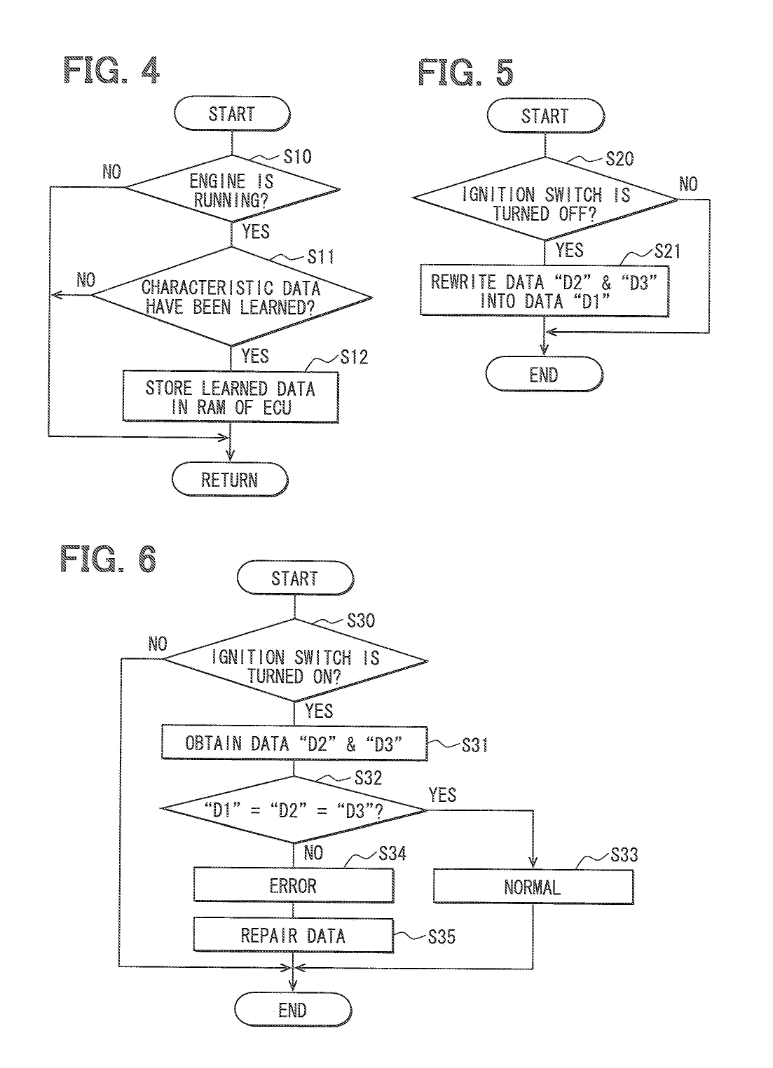

FIG. 4 is a flowchart showing a learning processing of characteristic data “D1” stored in the ECU-memory 31c after the engine is shipped into the market. The microcomputer 31 repeatedly executes this processing at a specified interval. In step S10, the computer 31 determines whether the engine is running. When the answer is YES, the procedure proceeds to step S11 in which the computer 31 determines whether the characteristic data have been learned. When the answer is YES in step S11, the procedure proceeds to step S12 in which the characteristic date “D1” in the ECU-memory 31c is updated.

In step S20 of FIG. 5, the microcomputer 31 determines whether an ignition switch is turned off. When the answer is YES, the procedure proceeds to step S21 in which the characteristic data “D1” stored in the ECU-memory 32 is transmitted to the INJ-memory 23a. Then, the characteristic data “D2”, “D3” stored in the INJ-memory 23a are rewritten into the characteristic data “D1” stored in the INJ-memory 23a. It should be noted that the process in step S21 is executed only once when the ignition switch is turned off.

According to the processing shown in FIG. 5, the characteristic data “D1”, “D2” and “D3” are respectively stored in different memory regions. If one of the data “D1”, “D2”, “D3” is different from the other data, the computer 31 determines that this date is damaged due to the failure of copying or noises. That is, the computer 31 determines that one of the data “D1”, “D2”, “D3” has an error. Further, the computer 31 determines that the other data are normal data, so that the characteristic data having an error is rewritten into the normal characteristic data.

FIG. 6 is a flowchart showing a processing for detecting an error and repairing the error in the characteristic data. The microcomputer 31 repeatedly executes the processing at specified intervals. In step S30, the computer 31 determines whether an ignition switch is turned on. When the answer is YES, the procedure proceeds to step S31 in which the characteristic data “D2”, “D3” in the INJ-memory 23a are obtained.

In step S32 (comparing means), the computer 31 compares the characteristic data

“D1” in the ECU-memory 32 with the characteristic data “D2”, “D3” in the INJ-memory 23a which are obtained in step S31. Then, the computer 31 determines whether all of characteristic data “D1”, “D2”, “D3” are identical to each other.

Each of the characteristic data “D1”, “D2”, “D3” is comprised of a plurality of datum (datum “A”, data “B” . . . in FIG. 3). Specifically, each datum corresponds to a value indicative of a correlation between the pulse-on timing “Tq” and the actual fuel injection quantity “Q”, the maximum injection-rate, and a correlation value between a response delay time and a correlation value “Tq-Q”. Further, the base data, which are previously obtained by experiments, may be stored as the characteristic data “D1”, “D2”, “D3” in addition to the updated data.

In step S32, with respect to every data, the computer 31 determines whether three characteristic data “D1”, “D2” and “D3” are identical to each other. When the answer is YES in step S32, the procedure proceeds to step S33 in which the computer 31 determines that no error exists in the characteristic data “D1”, “D2” and “D3” (normal condition). Meanwhile, when the answer is NO in step S32, the procedure proceeds to step S34 in which the computer determines that an error exists in the characteristic data “D1”, “D2” or “D3” (error condition).

Specifically, an error may arise in step S21, step S12 and the like.

In a case that the fuel injector 10 mounted in the engine is replaced by a new fuel injector, it is necessary that the base data (characteristic data D1) stored in the RAM 31c is rewritten into new base data (characteristic data D2, D3) and the updated data (characteristic data D1) stored in the RAM 31c is reset to zero. However, it is likely that the fuel injector 10 may be replaced improperly without rewriting and resetting the data. If such an improper replacement of the fuel injector 10 is conducted, the computer 31 determines that an error exists in step S34.

In step S35, the computer 31 determines which data “D1”, “D2”, or “D3” has an error. For example, when the characteristic data “D3” is different from the characteristic data “D1” and “D2” and when the characteristic data “D1” is identical to the characteristic data “D2”, the computer 31 determines that the characteristic data “D1” and “D2” have no error and the characteristic data “D3” has an error. Then, the characteristics data “D3” having an error is rewritten into the characteristics data “D1”, “D2”, whereby the characteristic data “D3” is repaired.

The processing in steps S31 to S35 is executed only once when the ignition switch is turned on. Besides, the learning processing shown in FIG. 4, the updating processing shown in FIG. 5 and the error determination processing shown in FIG. 6 are executed with respect to each of multiple fuel injectors 10.

As described above, according to the present embodiment, three characteristic data “D1”, “D2” and “D3” are stored and the computer determines whether these three data “D1”, “D2” and “D3” are identical to each other in order to detect an error. Thus, the computer 31 can identify the data having an error.

Further, all of three data ““D1”, “D2” and “D3” is not stored in the INJ-memory 23a. One characteristic data “D1” is stored in the ECU-memory 31c. Thus, the storage capacity of the INJ-memory 23a can be reduced.

Besides, since the INJ-memory 23a stores the initial base data which are obtained before shipping, the INJ-memory 23a should be a nonvolatile memory. Meanwhile, the ECU-memory 31c should be a volatile memory. Since one of characteristic data is stored in the ECU-memory 31c, the storage capacity of the INJ-memory 23a can be reduced.

According to the present embodiment, sirice the characteristic data “D1”, “D2” and “D3” include the updated data, if the fuel injector 10 is improperly replaced, the ECU-memory 31c stores the updated data, but the INJ-memory 23a does not store the updated data. In such a case, the computer determines that an improper replacement of the fuel injector 10 has been conducted. Thus, without storing the manufacturing serial number of the fuel injector 10 in the ECU-memory 31c and the INJ-memory 23a, the above improper replacement of the fuel injector 10 can be detected. When the improper replacement of the fuel injector 10 is detected, the updated data in the ECU-memory 31c is reset to zero.

### Other Embodiment

The present invention is not limited to the embodiments described above, but may be performed, for example, in the following manner. Further, the characteristic configuration of each embodiment can be combined.

In the above embodiment, two characteristic data are stored in the INJ-memory 23a and one characteristic data is stored in the ECU-memory 31c. Alternatively, one characteristic data may be stored in the INJ-memory 23a and tow characteristic data may be stored in the ECU-memory 31c.

In the above embodiment, three characteristic data are stored. Alternatively, four or more characteristic data may be stored in the INJ-memory 23a and the ECU-memory 31c.

A rewritable nonvolatile memory, such as an EEPROM, may be provided to the ECU 30. In step S21, the data in the INJ-memory 23a and the rewritable nonvolatile memory may be rewritten to be updated. According to this, even if the in-vehicle battery is removed and the backup electricity can not be supplied, the characteristic data can be kept in the ECU 30. Thus, the reliability of the characteristic data can be improved.

In the above embodiment, with respect to both base data and updated date, the computer determines whether the three characteristic data are the same. Alternatively, with respect to one of the data, the computer may determine whether the three characteristic data are the same.

The INJ-memory 23a may be provided to the body 11 or the connector 14.

What is claimed is:

1. An error detector for injection characteristic data, comprising:
an injector-memory means provided to a fuel injector injecting a fuel into an internal combustion engine, the injector-memory means storing a first characteristic data indicative of an injection characteristics of the fuel injector; and
a controller-memory means provided to a controller controlling the fuel injector, the controller-memory means storing a second characteristic data which is identical to the first characteristic data, wherein
at least one of the injector-memory means and the controller-memory means further stores a third characteristic data which is identical to the first and the second characteristic data, and
at least the first to the third characteristic data is compared with each other in order to detect an error in one of the characteristic data.

2. An error detector for injection characteristic data according to claim 1, wherein
the injector-memory means is a nonvolatile memory and the controller-memory means is a volatile memory.

3. An error detector for injection characteristic data according to claim 2, wherein
two of the characteristic data are stored in the injector-memory means and one of the characteristic data is stored in the controller-memory means.

4. An error detector for injection characteristic data according to claim 1, wherein
the characteristic data includes a base data which is obtained by an experiment before the internal combustion engine is shipped into a market and an updated data which is obtained after the internal combustion engine is shipped into a market, and
at least three updated data stored in the injector-memory means and the controller-memory means are updated at a specified timing.
